(19) United States
(12) Patent Application Publication
(10) Pub. No.: US 2008/0246900 A1
(43) Pub. Date: Oct. 9, 2008

(54) Liquid Crystal Accessories

(76) Inventors: Bahman Taheri, Hudson, OH (US); Roy Miller, Akron, OH (US); Joshua Hupper, Stow, OH (US); Tamas Kosa, Hudson, OH (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 10/554,070

(22) PCT Filed: Apr. 23, 2004
(86) PCT No.: PCT/US04/12583

§ 371 Date: Sep. 22, 2006

Related U.S. Application Data
(60) Provisional application No. 60/465,196, filed on Apr. 24, 2003.

(51) Int. Cl. G02F 1/1333

(52) U.S. Cl. 349/58

(57) ABSTRACT

An accessory article incorporating liquid crystal materials includes at least one liquid crystal cell and at least one formable member for carrying the liquid crystal cell. The article includes a driving circuit connected to the at least one liquid crystal cell to control the appearance thereof. The liquid crystal cell comprises a pair of opposed substrates, wherein each the substrate has an electrode disposed thereon and facing the other the substrate with a gap that receives the liquid crystal material. Application of an electric field by the driving circuit allows the liquid crystal cell to reflect a desired color and in a desired logo or shape.

### TECHNICAL FIELD

The present invention is generally directed to liquid crystal accessory for the fashion industry. In particular, the present invention is directed to electronically controlled liquid crystal cells attached to a formable carrier for the purposes of enhancing the features of the accessory or to make the accessory more immune to copies.

### BACKGROUND ART

In fashion, brands are established based on originality in clothing and accessories such as jewelry, belts, and handbags. Once recognized, the brand name and the associated logo are considered more valuable than some of the actual designs and the logo itself can be considered an accessory. Therefore, there is a great need to ensure that low cost versions of the accessory are not sold illegally since that can have a significant impact on the brand and the associated cost. Among exemplary branded entities such as Chirstian Dior or Gucci there is great interest to distinguish using different designs and functionality to increase the value of the brand. A recent approach in this area is the incorporation of active elements. For example, it is known in the prior art to provide lighting elements, such as light-emitting diodes, in conjunction with necklaces and other types of jewelry. Although such configurations are interesting, these products have not seen expansion in high end or mainstream fashion markets. The main reason for this lack of acceptance is the emissive nature of the technology used. Reflection of ambient light is the main focus of all fashion and is achieved using cut crystals, chains, or even cloths. It is difficult to control the light intensity and appearance of the lighting elements so as to provide a tasteful display of the jewelry without overwhelming the visual senses of the viewer. Unlike reflection, emissive systems are ambient light independent and tend to be either too bright or too dim thus providing more of a distracting appearance rather than enhancing the appearance of the wearer. Moreover, such devices provide only discrete points or lines of light and are not able to be easily presented on a wide surface area. Accordingly, the light sources are easily identifiable and the light is not diffused in a pleasing manner. Therefore, there is a need in the art for technologies which provide electrically controllable elements to modify ambient light reflections in a more pleasing appearance consistent with the requirements of fashion-driven industry.

Liquid crystals devices are used in a number of applications including laptop monitors and projectors. Currently most devices utilize a polarizer-based configuration. In addition, these technologies are implemented on glass or other rigid substrates that are rectangular in construction. As such, these devices are not considered as potential devices for accessories where flexibility, and curvature are essential.

Recently, application of liquid crystals on plastic substrates has been studied; although there are currently no commercial products based on these substrates. U.S. patent application Ser. No. 09/956,507 entitled “A Doubly Curved Optical Device For Eyewear And Method For Maling” filed by the assignee of this application, outlines a method for forming a flexible, single or doubly curved liquid crystal cell with a variety of shapes. In addition to the formable substrates, it is necessary to use a technology where the refection of ambient light is controlled for amplitude, color and tint. But, the aforementioned application is lacking in that it does not provide for imparting an indicia or distinctive logo into the liquid crystal cell, nor does the application provide a carrying mechanism so that the cell is usable as a fashion accessory. Accordingly, there is a need for a system of guest-host liquid crystal or a reflective liquid crystal technology to be used with fashion accessories. And there is a need for a liquid crystal cell that can be placed on a reflective surface such as a mirror or a scattering medium or otherwise constructed to display a logo.

### SUMMARY OF THE INVENTION

Therefore, there is a need in the art for accessories incorporating electronic liquid crystal devices to control ambient light attached to a formable carrier.

One object of this invention is to achieve controllable accessories for the fashion industry by implementing a reflective liquid crystal technology combined with flexible substrates implemented on a formable carrier.

Another object of the present invention, which shall become apparent as the detailed description proceeds, is achieved by an article of fashion accessory incorporating liquid crystal materials, comprising at least one liquid crystal cell; and at least one formable carrier where said liquid crystal cell is attached thereto.

These and other objects of the present invention, as well as the advantages thereof over existing prior art forms, which will become apparent from the description to follow, are accomplished by the improvements hereinafter described and claimed.

### BRIEF DESCRIPTION OF THE DRAWINGS

For a complete understanding of the objects, techniques and structure of the invention, reference should be made to the following detailed description and accompanying drawings, wherein:

FIG. 1 is an elevational view of an article of jewelry according to the present invention;

FIG. 1A is a cross-sectional view of an elongated formable carrier employed for carrying a liquid crystal cell incorporating the concepts of the present invention;

FIG. 2A is a schematic diagram of an accessory utilizing a single liquid crystal cell according to the present invention;

FIG. 2B is an elevational view of the cell showing an example of displayed indicia;

FIG. 2C is a schematic diagram of an alternative accessory utilizing a stacked liquid crystal cell;

FIG. 3 is elevational view of an alternative embodiment of the article of jewelry according to the present invention; and

FIG. 4 is a side elevational view of the alternative embodiment according to the present invention.

### BEST MODE FOR CARRYING OUT THE INVENTION

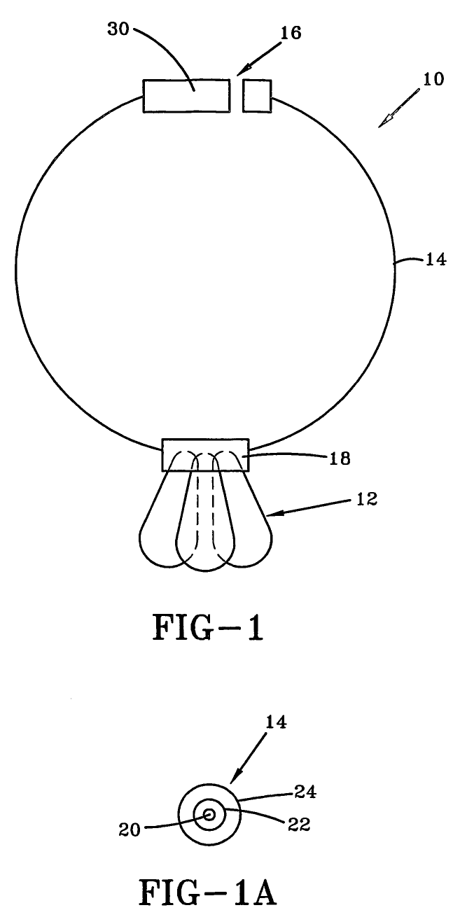

Referring now to the drawings and in particular to FIG. 1 it can be seen that an accessory according to the present invention is designated generally by the numeral 10. The article 10 is shown in the form of a necklace but it will be appreciated that any item of accessory such as a logo, earrings, pendants, tiaras and the like may incorporate the teachings of the present invention. Moreover, the teachings of the present invention may also be used to adorn other items including handbags, belts, ties, scarves, hats and the like. The article 10 includes at least one liquid crystal cell designated generally by the numeral 12. As will be discussed in further detail the cell 12 is electronically addressable and switchable between a more reflective color and a less reflective appearance and if desired, in a periodic sequence. In order to obtain a pleasing appearance it will be appreciated that the liquid crystal cell is non-emissive and does not contain polarizers. In other words, use of a polarizer with the cells is not recommended as such a device tends to reduce the amount of reflected light. On the other hand, it is also desired that the cells not be emissive which might also be considered to detract from the appearance of the article 10.

Preferably, the liquid crystal material contained within the cell may exhibit various types of tints, transmission, colors and/or color combinations depending upon the number of cells employed. The cell 12 is carried by at least one elongated member 14 which is preferably a flexible or formable member such as an elastic material or a braided sleeve, wherein the sleeve is made from cloth or flexible metallic material commonly found in accessories. Indeed, the formable member could be any material that is bendable or malleable to a desired shape. Attached to the distal ends of each member 14 is a power clasp 16 which connects the ends of the members 14 to one another. The power clasp 16 may carry a power supply and driving circuit as will be discussed in detail as the description proceeds. A cover 18 may be employed to attach proximal ends of the elongated members 14 to the at least one liquid crystal cell 12.

Referring now to FIG. 1A it can be seen that a cross-sectional view of the member 14 is shown. In order to apply an electrical field to the liquid crystal cell 12 the elongated member 14 may have contained therein a conductive wire 20. The wire 20 is typically a smaller gauge wire with fine standing to permit maximum flexure of the member if needed. The wire 20 is surrounded by a layer of insulation which is also flexible, although it will be appreciated that a stiffer inflexible wire and insulation material could be selected. A sheath 24, which is decorative in nature and matches the appearance of the cover and the liquid crystal cell as deemed appropriate, may enclose the insulation 22.

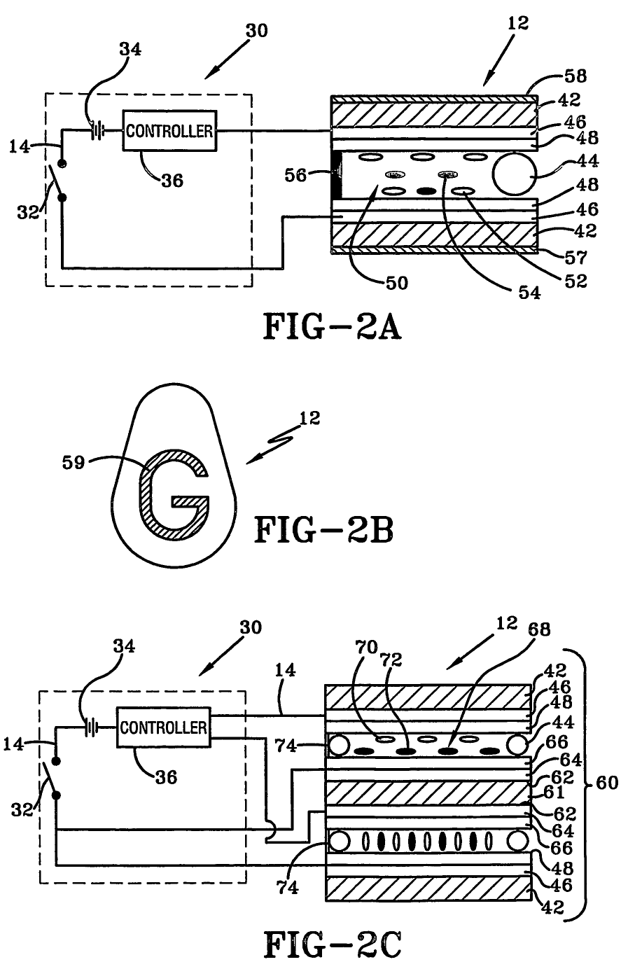

Referring now to FIGS. 2A and 2B it can be seen that a driving circuit is designated generally by the numeral 30. The driving circuit 30 is connected to the liquid crystal cell 12 so as to provide application of an electrical field to the liquid crystal cell. The driving circuit 30 includes an on/off switch 32 that is connected at one end to terminal of a power supply 34. The power supply 34 is preferably a relative low voltage battery—no more than 9V—such as a lithium ion battery or equivalent. And the supply 34 is as small and light as possible. The other terminal of the power supply 34 is connected to a controller 36. Controller 36 is a processor with the necessary memory, hardware and software for implementing a driving sequence for application of an electric field to the liquid crystal cell 12. In particular, the controller 36 controls at least the on/off time of the cell, the sequence of illumination if connected to multiple cells, the intensity of reflection and other variables of the electrical operation of the liquid crystal cell. The controller 36 is connected to the conductive wire 20 for transmitting the appropriate signals to the liquid crystal cell 12.

Referring now to FIG. 2A it can be seen that a single layer liquid crystal cell is designated generally by the numeral 40. The cell 40 includes a pair of opposed substrates 42 which are preferably made of a light weight plastic material, although other substrate material such as glass could be used. The substrates 42 are separated by a plurality of spacers 44 which maintain a predetermined gap thickness which is typically about 5 microns but which can vary according to the particular appearance desired by the cell 40. Disposed on the facing surfaces of each substrate 42 is an electrode 46 which is preferably indium tin oxide or other transparent electrically conductive material. Disposed on each facing electrode 46 is an alignment layer 48 which controls the orientation of the liquid crystal material 50 that is disposed between the substrates 42. Any type of liquid crystal material that is responsive to an electric field may be disposed between the substrates. In the preferred embodiment, the liquid crystal material 50 is a guest-host type wherein the liquid crystal material is a chiral nematic or achiral nematic liquid crystal 52 and the guest material is a dye 54. An edge sealant 56 is disposed about the outer periphery of the cell to contain the liquid crystal material within the gap formed between the substrates 42.

Application of an electric field by the controller 14 across the electrodes 46 causes the host liquid crystal material to change its molecular orientation according to the orientation of the alignment layers 48 when an electric field is not applied. By adjusting the orientation of the liquid crystal material, the dye, which typically maintains the same orientation as the liquid crystal material, will mimic the orientation of the liquid crystal molecules. Accordingly, the dye absorbs a particular wavelength of light. When transparent substrates are utilized with the cell and when an electric field is applied, the cell reflects the color of the dye. Alternatively, a chiral nematic or cholesteric liquid crystal material may be employed. Indeed, any liquid crystal material that is reflective upon application of an electric field or which changes states upon application of an electric field may be employed in the cell 10. And the substrate furthest from the viewer may either be mirrored, reflective, or tinted with a desired color that is compatible with the reflective properties of the liquid crystal. Indeed, the cell may be placed between two additional layers to alter the reflection properties. A back layer 57 may be disposed on an outwardly facing surface of one of the substrates. The back layer 57 may be a reflective material such as a mirror or scattering surface, or an absorbing surface. By using a cut crystal as a top layer 58 on the other substrate's outwardly facing surface, the incident light properties may be altered to enhance the effect. The optional layers 57 and 58 may be patterned as desired to provide a fanciful design, logo, trademark or the like to the accessory. Moreover, one or both electrodes 48 may be patterned in such a way to complement the layers 57 and 58. An exemplary accessory is shown in FIG. 2B, wherein the cell includes an indicia 59. Such an indicia, which would be very difficult to counterfeit, provides a distinctive design element to the accessory. In other words, the unique properties of the liquid crystal material, the alignment layers, the patterned electrodes, and the layers 57, 58 coact with one another to provide a distinctive accessory that is pleasing in appearance and difficult to copy due to the relative complexity of the cell's construction and the resulting indicia 59.

Referring now to FIG. 2C it can be seen that a multi-layer liquid crystal cell is designated generally by the numeral 60. The construction of the cell 60 is much like that of the cell 40 except that an interposed substrate 61 is positioned between the opposed substrates 42. The interposed substrate 61 provides facing surfaces 62 which have disposed thereon electrodes 64 which in the preferred embodiment are indium tin oxide. Disposed on each of the electrodes 64 is an alignment layer 66 if required.

A liquid crystal material 68 is disposed between the respective gaps formed between the opposed substrates and the interposed substrates wherein the liquid crystal material includes a host 70 and a guest material such as a dye 72. As in the cell 40, the outer perimeter of the multi-layered cell is sealed with an edge sealant 74. The multi-layered cell allows for multiple colors to be exhibited during operation of the liquid crystal jewelry 10. In other words, the first layer may exhibit a color such as red while the second layer may exhibit a color such as yellow As such, when only the first layer of the cell is energized a red color may appear and when only the other layer of liquid crystal material is energized a yellow color will appear. By energizing both layers simultaneously an orange color appears. Accordingly, the controller 36 may be employed to sequence through the various stages of illumination in a predetermined manner so as to provide the desired appearance deemed appropriate by the wearer of the jewelry. Of course, it will be appreciated that any reasonable number of layers may be employed to obtain a desired sequence of colors and that patterned electrodes and layers 57, 58 may likewise be employed.

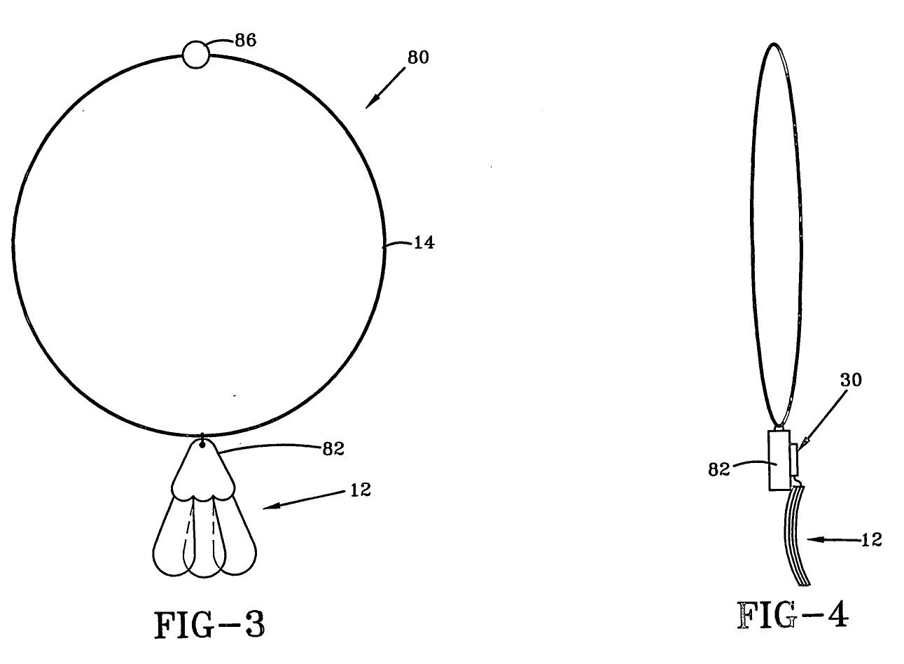

Referring now to FIGS. 3 and 4 it can be seen that an alternative liquid crystal accessory is designated generally by the numeral 80. The accessory 80 incorporates the liquid crystal cells 12 as previously disclosed and which are carried by a cover plate 82. In this embodiment, a driving circuit 84 is embedded or secured to a least one side of the cover plate 82 so as to avoid the need for making attachments of the battery and driving circuit in the clasp of the necklace. Accordingly, a standard clasp 86 is used to attach the members 14 to one another. In FIG. 4 it can be seen that the liquid crystal cells 12 may be formed to exhibit a curved or doubly curved shape as deemed appropriate. A method of obtaining the curved or doubly curved shape is disclosed in U.S. patent application Ser. No. 09/956,507 entitled “Doubly Curved Optical Device For Eyewear And Method For Making The Same” which is owned by Assignee of the present application and incorporated herein by reference. Briefly, a curved or doubly curved liquid crystal cell is obtained by employing a plastic material for the substrates 42 and 61. The cell is filled with the appropriate liquid crystal material and sealed. The cell is preferably thermoformed so as to deform the plastic substrates. The cell is then cooled an appropriate time so as to leave a liquid crystal cell which has a curved or doubly curved shape. Accordingly, the present invention allows for formation of a liquid crystal accessory which has various shapes and configurations. And the material of the substrates may be selected such that they remain flexible even after the cell has been formed and return to their originally formed shape after flexure.

Based upon the foregoing the advantages of the present invention are readily apparent. In particular, the present invention allows for liquid crystal cells to be incorporated into jewelry or related accessories in a manner not previously known. In particular, the present invention allows for at least one and preferably multiple liquid crystal cells to be connected to an elongated formable member which provides a power connection and driving circuit that allows for selective illumination of the particular liquid crystal cells in a predetermined order. Additionally, the present invention allows for multiple colors to be generated by a single cell which can be further used in combination with other liquid crystal cells to provide a distinctive and unique presentation of the jewelry or accessory for the benefit of the person wearing the jewelry. Moreover, the present invention allows for liquid crystal jewelry wherein the liquid crystal cells are either planar, curved or doubly curved depending upon the particular end use. The cells are also advantageous in that they can be provided in distinctive patterns either by utilizing patterned electrodes and/or patterned covering layers that exhibit reflective, scattering, and or refractive properties.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

1. An accessory article incorporating liquid crystal materials, comprising:
at least one liquid crystal cell; and
at least one formable member for carrying said at least one liquid crystal cell at an end thereof.

2. The article according to claim 1, further comprising:
a driving circuit connected to said at least one liquid crystal cell to control the appearance thereof.

3. The article according to claim 2, further comprising:
a clasp for connecting distal ends of said formable members to one another.

4. The article according to claim 3, wherein said clasp carries said driving circuit.

5. The article according to claim 3, wherein said formable member is an insulated conductor.

6. The article according to claim 2, wherein said at least one liquid crystal cell comprises:
a pair of opposed substrates, each said substrate having an electrode disposed thereon and facing the other said substrate with a gap therebetween; and
a liquid crystal material disposed in said gap.

7. The article according to claim 6, further comprising:
an alignment layer disposed on each said electrode.

8. The article according to claim 7, wherein said liquid crystal material is chiral nematic.

9. The article according to claim 7 comprises a liquid crystal host and a dye guest.

10. The article according to claim 6, wherein said pair of opposed substrates are curved.

11. The article according to claim 6, wherein said pair of opposed substrates are doubly curved.

12. The article according to claim 6, wherein said driving circuit comprises:
a power supply; and
a controller connected to said power supply and said electrodes, said controller applying an electric field to said electrodes so as to alter liquid crystal material and control the appearance thereof.

13. The article according to claim 12, wherein said controller applies said electric field in a predetermined sequence.

14. The article according to claim 12, wherein said electrodes are patterned to generate an indicia when said electric field is applied to said electrodes.

15. The article according to claim 12, further comprising:
a layer disposed on at least one of said opposed substrates to alter the appearance of at least selected portions of said cell.

16. The article according to claim 15, wherein said layer is reflective.

17. The article according to claim 15, wherein said layer has light altering properties.

18. The article according to claim 2, wherein said at least one liquid crystal cell comprises:
a pair of outer substrates, each said outer substrate having an outer electrode disposed thereon;
at least one interposed substrate having opposed surfaces, each said opposed surface having an interposed electrode disposed thereon, said interposed electrodes facing either one of said outer electrodes on another of said interposed electrodes, said outer substrates and said interposed substrates forming gaps therebetween; and
a different liquid crystal material received in each of said gaps.

19. The article according to claim 18, wherein said driving circuit comprises:
a power supply; and
a controller connected to said power supply and said electrodes, said controller applying an electric field to said liquid crystal material to control the appearance thereof.

20. The article according to claim 19, wherein said controller applies said electric fields across said gaps in a predetermined sequence.

21. The article according to claim 1, wherein said elongated member is flexible.

22. The article according to claim 1, wherein one of said substrates is reflective.

23. The article according to claim 1, wherein one of said substrates is tinted.

24. The article according to claim 1, wherein said at least one liquid crystal cell is polarizer-free.

25. An accessory article incorporating liquid crystal materials, comprising:
a pair of opposed substrates, each said substrate having an electrode disposed thereon and facing the other said substrate with a gap therebetween;
a liquid crystal material disposed in said gap;
at least one formable member for carrying said pair of substrates at an end thereof;
a driving circuit connected to said electrodes to control the appearance of said liquid crystal material;
said driving circuit comprising:
a power supply; and
a controller connected to said power supply and said electrodes, said controller applying an electric field to said electrodes so as to alter liquid crystal material and control the appearance thereof, wherein said electrodes are patterned to generate an indicia when said electric field is applied to said electrodes.

26. The article according to claim 25, further comprising:
a clasp for connecting distal ends of said formable members to one another, wherein said clasp carries said driving circuit.

27. The article according to claim 26, further comprising:
an alignment layer disposed on each said electrode.

28. The article according to claim 27, wherein said liquid crystal material is chiral nematic.

29. The article according to claim 27, wherein said liquid crystal material comprises a liquid crystal host and a dye guest.

30. The article according to claim 25, wherein said pair of opposed substrates are curved.

31. The article according to claim 25, wherein said pair of opposed substrates are doubly curved.

32. The article according to claim 25, wherein said controller applies said electric field in a predetermined sequence.

33. The article according to claim 25, further comprising:
at least one interposed substrate having opposed surfaces, each said opposed surface having an interposed electrode disposed thereon, said interposed electrodes facing either one of said outer electrodes on another of said interposed electrodes, said outer substrates and said interposed substrates forming gaps therebetween; and
a different liquid crystal material received in each of said gaps.

34. The article according to claim 33, wherein said controller connected to said interposed electrodes, said controller applying an electric field to said liquid crystal material to control the appearance thereof.

35. The article according to claim 34, wherein said controller applies said electric fields across said gaps in a predetermined sequence.

36. The article according to claim 25, wherein said at least one liquid crystal cell is polarizer-free.
